(19) United States
(12) Patent Application Publication
(10) Pub. No.: US 2008/0007489 A1
(43) Pub. Date: Jan. 10, 2008

(54) APPARATUS FOR DRIVING PLASMA DISPLAY PANEL

(76) Inventor: Jeong Pil CHOI, Suwon-si (KR)

Correspondence Address: BIRCH STEWART KOLASCH & BIRCH, PO BOX 747, FALLS CHURCH, VA, 22040-0747, US

(21) Appl. No.: 11/773,877

(22) Filed: Jul. 5, 2007

(30) Foreign Application Priority Data
Jul. 4, 2006 (KR) 10-2006-0062584

(51) Int. Cl. G09G 3/28

(52) U.S. Cl. 345/68

(57) ABSTRACT

A driving apparatus for applying a data signal to each of a plurality of address electrodes of a plasma display panel is disclosed. The driving apparatus includes a plurality of data integrated circuits (ICs) that apply the data signal to the address electrodes depending on input data, and a plurality of energy recovery circuits that recover a voltage applied to the address electrodes, and are charged to the recovered voltage. Voltages charged to the plurality of energy recovery circuits are different depending on changes in data input to the data ICs connected to the energy recovery circuits.

This application claims priority to and the benefit of Korea Patent Application No. 10-2006-0062584, filed in Korea on Jul. 4, 2006 which is hereby incorporated herein by reference in its entirety.

### FIELD

This document relates to an apparatus for driving a plasma display panel.

### DESCRIPTION OF THE BACKGROUND ART

A plasma display panel generally has the structure in which barrier ribs formed between an upper substrate and a lower substrate form unit discharge cell or discharge cells. Each discharge cell is filled with an inert gas containing a main discharge gas such as neon (Ne), helium (He) or a mixture of Ne and He, and a small amount of xenon (Xe). When the plasma display panel is discharged by the application of a high frequency voltage to the unit discharge cell, the inert gas generates vacuum ultraviolet rays, which thereby cause phosphors formed between the barrier ribs to emit light, thus displaying an image. Since the plasma display panel can be fabricated to be thin and light, it has attracted attention as a next generation display device.

The plasma display panel is generally driven with unit frame displaying an image being time-divided into a plurality of subfields. Each subfield is subdivided into a reset period during which all discharge cells are initialized, an address period during which discharge cells to be turned on are selected, and a sustain period during which a sustain discharge is generated in the selected discharge cells in accordance with gray weight assigned to each subfield.

During the address period, a data signal is applied to an address electrode of the discharge cell to be turned on in response to data to be displayed. However, much power is consumed in the application of the data signal due to a very large amount of data.

### SUMMARY

Accordingly, this document provides an apparatus for driving a plasma display panel capable of performing high-speed addressing during the driving of the plasma display panel and reducing power consumption data to be displayed.

In one aspect, a driving apparatus for applying a data signal to each of a plurality of address electrodes of a plasma display panel, the driving apparatus comprises a plurality of data integrated circuits (ICs) that apply the data signal to the address electrodes depending on input data, and a plurality of energy recovery circuits that recover a voltage applied to the address electrodes, and are charged to the recovered voltage, wherein voltages charged to the plurality of energy recovery circuits are different depending on changes in data input to the data ICs connected to the energy recovery circuits.

Implementations may include one or more of the following features. For example, the plurality of data ICs may be divided into data IC groups including one or more data ICs, and the plurality of energy recovery circuits may be connected to the data IC groups, respectively.

The data change may indicate the change amount from a high level to a low level of the data signal or the change amount from a low level to a high level of the data signal.

As the change in the data input to the data IC decreases, a voltage charged to the energy recovery circuit connected to the data IC may increase.

In another aspect, a driving apparatus for applying a data signal to each of a plurality of address electrodes of a plasma display panel, the driving apparatus comprises a plurality of data ICs that apply the data signal to the address electrodes depending on input data; and a plurality of energy recovery circuits that recovers a voltage applied to the address electrodes, and are charged to the recovered voltage, wherein voltages charged to the plurality of energy recovery circuits are different depending on changes in data input to the data ICs connected to the energy recovery circuits, the energy recovery circuit including a first switch that recovers a voltage applied to the address electrode, an energy recovery capacitor that is charged to a voltage recovered from the address electrode, an inductor that is connected to the data IC, the inductor and the plasma display panel forming a resonance circuit, and a second switch that is connected between an address voltage source and the data IC.

Implementations may include one or more of the following features. For example, the first switch may be positioned on a path for recovering a voltage from the address electrode and a path for recovering a voltage from the energy recovery capacitor and supplying the recovered voltage to the plasma display panel.

One terminal of the first switch may he connected to the energy recovery capacitor, and the other terminal is grounded.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are comprised to provide a further understanding of the invention and are incorporated in and constitute a part of this specification, illustrate embodiments of the invention and together with the description serve to explain the principles of the invention. In the drawings:

FIG. 1 is a perspective view of a structure of a plasma display panel according to an exemplary embodiment;

FIG. 2 illustrates an electrode arrangement of a plasma display panel according to an exemplary embodiment;

FIG. 3 illustrates a method for time-driving a plasma display panel in which a frame is divided into a plurality of subfields;

FIG. 4 is a timing diagram of driving signals for driving a plasma display panel according to an exemplary embodiment;

FIGS. 5a and 5b illustrate a first embodiment of a configuration of an address driving circuit of a plasma display panel according to an exemplary embodiment;

FIG. 6 illustrates On/Off timing of switches of FIGS. 5a and 5b and a waveform of a data signal applied to a plasma display panel according to an exemplary embodiment;

FIG. 7 is a circuit diagram of a second embodiment of a configuration of an address driving circuit of a plasma display panel according to an exemplary embodiment;

FIGS. 8a and 8b illustrate data supplied to an address electrode line;

FIGS. 9a to 9c are graphs showing a relationship between a data change and a voltage charged to a capacitor of an energy recovery circuit;

FIG. 10 schematically illustrates a form of a data signal produced by an address driving circuit according to an exemplary embodiment;

FIGS. 11a and 11b illustrate a third embodiment of a configuration of an address driving circuit of a plasma display panel according to an exemplary embodiment;

FIG. 12 is a circuit diagram of a fourth embodiment of a configuration of an address driving circuit of a plasma display panel according to an exemplary embodiment; and

FIG. 13 is a circuit diagram of a fifth embodiment of a configuration of an address driving circuit of a plasma display panel according to an exemplary embodiment.

### DETAILED DESCRIPTION OF EMBODIMENTS

Reference will now be made in detail embodiments of the invention examples of which are illustrated in the accompanying drawings.

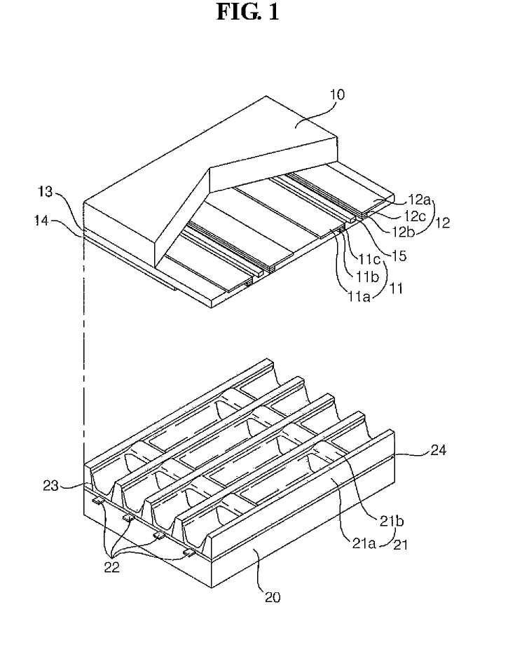

FIG. 1 is a perspective view of a structure of a plasma display panel according to an exemplary embodiment.

As illustrated in FIG. 1, a plasma display panel includes an upper substrate 10 and a lower substrate 20. Scan electrodes 11 and sustain electrodes 12 are formed on the upper substrate 10, and make a plurality of maintenance electrode pairs. Address electrodes 22 are formed on the lower substrate 20.

The maintenance electrode pair 11 and 12 each include transparent electrodes 11a and 12a generally made of indium-tin-oxide (ITO) and bus electrodes 11b and 12b. The bus electrodes 11b and 12b may be formed of a metal such as silver (Ag) and chromium (Cr), or may be formed by stacking Cr, copper (Cu) and Cr or Cr, aluminum (Al) and Cr. The bus electrodes 11b and 12b is formed on the transparent electrodes 11a and 12a to reduce a voltage drop of the transparent electrodes 11a and 12a having a high resistance.

The maintenance electrode pair 11 and 12b each may include only the bus electrodes 11b and 12. In this case, since the transparent electrodes 11a and 12a are not used, fabrication cost of the plasma display panel is reduced. Further, the bus electrodes 11b and 12b may be formed of various materials such as a photosensitive material in addition to the above-described materials.

Black matrixes are arranged between the transparent electrodes 11a and 12a and the bus electrodes 11b and 12b. The black matrix performs a light shielding function by absorbing external light generated in the outside of the upper substrate 10, and improves purity and contrast of the upper substrate 10.

The black matrix is formed on the upper substrate 10. The black matrix includes a first black matrix 15 positioned on the upper substrate 10 overlapping a barrier rib 21, and second black matrixes 11c and 12c between the transparent electrodes 11a and 12a and the bus electrodes 11b and 12b. The second black matrixes 11c and 12c may be called a black layer or a black electrode layer. Because the first black matrix 15 and the second black matrixes 11c and 12c can be simultaneously formed, the first black matrix 15 and the second black matrixes 11c and 12c can be physically connected to each other. Further, because the first black matrix 15 and the second black matrixes 11c and 12c can be individually formed, the first black matrix 15 and the second black matrixes 11c and 12c cannot be physically connected to each other.

In case that the first black matrix 15 and the second black matrixes 11c and 12c are physically connected to each other, the first black matrix 15 and the second black matrixes 11c and 12c are formed of the same material. In case that the first black matrix 15 and the second black matrixes 11c and 12c are not be physically connected to each other, the first black matrix 15 and the second black matrixes 11c and 12c are formed of different materials.

An upper dielectric layer 13 and a protective layer 14 are stacked on the upper substrate 10 on which the scan electrodes 11 and the sustain electrodes 12 are formed in parallel. Charged particles generated by a discharge are accumulated on the upper dielectric layer 13 to protect the maintenance electrode pairs. The protective layer 14 protects the upper dielectric layer 13 from sputtering of charged particles generated by a gas discharge, and increases secondary electron emission efficiency.

The address electrodes 22 are formed to intersect the scan electrodes 11 and the sustain electrodes 12. A lower dielectric layer 23 and the barrier rib 21s are formed on the lower substrate 20 on which the address electrodes 22 are formed.

A phosphor layer is formed on the surfaces of the lower dielectric layer 23 and the barrier rib 21. The barrier rib 21 includes a longitudinal barrier rib 21a and a transverse barrier rib 21b in a closed type. The barrier ribs 21 physically partition discharge cells, and prevent a leakage of ultraviolet rays and visible light produced by a discharge into adjacent discharge cells.

The plasma display panel according an exemplary embodiment may have various forms of barrier rib structures as well as the structure of the barrier ribs 21 illustrated in FIG. 1. For instance, the barrier rib 21 may have a differential type barrier rib structure in which the height of the longitudinal barrier rib 21a and the height of the transverse barrier rib 21b are different from each other, a channel type barrier rib structure in which a channel usable as an exhaust path is formed on at least one of the longitudinal barrier rib 21a or the transverse barrier rib 21b, a hollow type barrier rib structure in which a hollow is formed on at least one of the longitudinal barrier rib 21a or the transverse barrier rib 21b, and the like.

In the differential type barrier rib structure, the height of the transverse barrier rib 21b may be higher than the height of the longitudinal barrier rib 21a. Further, in the channel type or hollow type barrier rib structure, a channel or a hollow may be formed on the transverse barrier rib 21b.

While the plasma display panel according to an exemplary embodiment has been illustrated and described to have red (R), green (G) and blue (B) discharge cells arranged on the same line, it is possible to arrange them in a different pattern. For instance, a delta type arrangement in which the R, G and B discharge cells are arranged in a triangle shape may be applicable. Further, the discharge cells may have a variety of polygonal shapes such as pentagonal and hexagonal shapes as well as a rectangular shape.

The phosphor layer emits light due to ultraviolet rays generated by a gas discharge, and emits one of R, G and B visible light. Discharge spaces provided between the upper and lower substrates 10 and 20 and the barrier ribs 21 are filled with an inert gas mixture such as He—Xe, Ne—Xe and He—Ne—Xe.

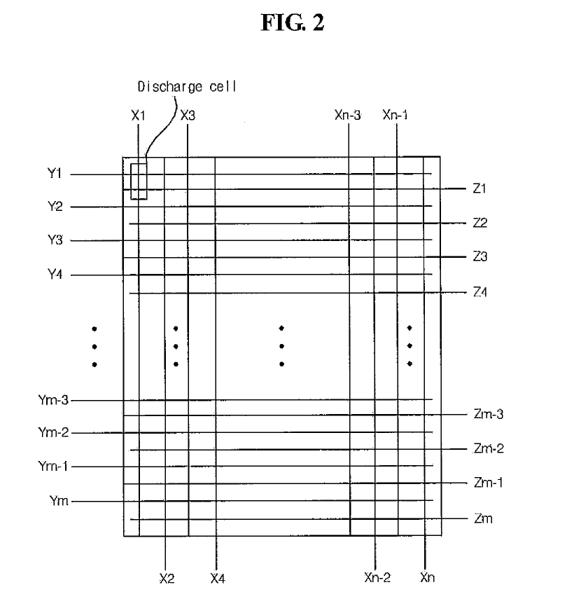

FIG. 2 illustrates an electrode arrangement of a plasma display panel according to an exemplary embodiment. As illustrated in FIG. 2, a plurality of discharge cells of the plasma display panel may be arranged in a matrix form. The plurality of discharge cells are provided at each intersection of scan electrode lines Y1 to Ym, sustain electrode lines Z1 to Zm, and address electrode lines X1 to Xn. The scan electrode lines Y1 to Ym may be sequentially or simultaneously driven. The sustain electrode lines Z1 to Zm may be simultaneously driven. The address electrode lines X1 to Xn may be sequentially driven. Further, the address electrode lines X1 to Xn may be driven with the address electrode lines X1 to Xn being divided into even-numbered address electrode lines and odd-numbered address electrode lines.

Although FIG. 2 illustrated only an example of the electrode arrangement of the plasma display panel according to an exemplary embodiment, the present invention is not limited thereto. For instance, a dual scanning type in which two scan electrode lines of the scan electrode lines Y1 to Ym are simultaneously scanned is applicable. Further, the address electrode lines X1 to Xn may be driven with the address electrode lines X1 to Xn being divided into an upper address electrode line group and a lower address electrode line group with respect to the center of the address electrode lines X1 to Xn.

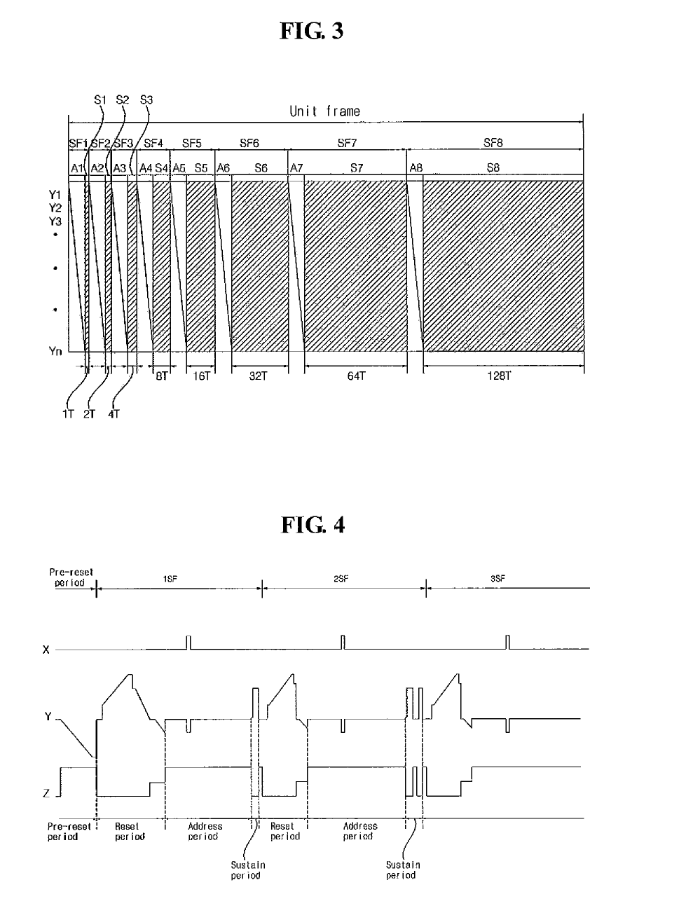

FIG. 3 illustrates a method for time-driving a plasma display panel in which a frame is divided into a plurality of subfields. A unit frame may be divided into a predetermined number of subfields, for example, 8 subfields SF1 to SF8 to achieve time-division gray scale. The subfield SF1 to SF8 may be subdivided into reset periods (not shown), address periods A1 to A8, and sustain periods S1 to S8, respectively.

The reset period may he omitted in at least one of the plurality of subfields. For instance, the reset period may exist in only a first subfield, or only a first subfield and a middle subfield.

During each address period A1 to A8, a display data signal is applied to address electrodes X, and a scan pulse corresponding to the display data signal is sequentially applied to each scan electrode Y.

During each sustain periods S1 to S8, a sustain pulse is alternately applied to the scan electrodes Y and sustain electrodes Z to generate a sustain discharge in discharge cells having wall charges accumulated during each address period A1 to A8.

A luminance of the plasma display panel is proportional to the number of sustain pulses generated during the sustain periods S1 to S8 of the unit frame. In case that one frame displaying one image is represented by 8 subfields and 256-level gray scale, a different number of sustain pulses in a ratio of 1, 2, 4, 8, 16, 32, 64 and 128 may be assigned to each of 8 subfields in turn. To obtain a luminance of 133-level gray scale, sustain discharges are performed by addressing discharge cells during the subfields SF1, SF3 and SF8.

The number of sustain discharges assigned to each subfield may variably determined depending on gray weights of the subfields in accordance with an automatic power control (APC) stage. In other words, while FIG. 3 illustrates a case where one frame is divided into 8 subfields as an example, the present invention is not limited thereto. The number of subfields constituting one frame may be variously changed based on the design specification of the panel. For instance, one frame may include 12 or 16 subfields.

The number of sustain discharges assigned to each subfield may be variously changed in consideration of a gamma characteristic or a panel characteristic. For instance, a gray scale assigned to the subfield SF4 may be reduced from 8 to 6, and a gray scale assigned to the subfield SF6 may be raised from 32 to 34.

FIG. 4 is a timing diagram of driving signals for driving a plasma display panel according to an exemplary embodiment in one subfield.

The subfield includes a pre-reset period, a reset period, an address period, and a sustain period. During the pre-reset period, positive wall charges are formed on the scan electrodes Y and negative wall charges are formed on the sustain electrodes Z. During the reset period, discharge cells of the entire screen are initialized using wall charge distribution formed during the pre-reset period. During the address period, cells to be discharged are selected. During the sustain period, discharges of the selected discharge cells are maintained.

The reset period includes a setup period and a set-down period. During the setup period, a rising waveform is simultaneously applied to all the scan electrodes Y, thereby generating a fine discharge (i.e. a setup discharge) within the discharge cells of the entire screen. This leads in the formation of wall charges. During the set-down period, a falling waveform which falls from a positive voltage lower than a peak voltage of the rising waveform is simultaneously applied to all the scan electrodes Y, thereby generating an erase discharge (i.e. a set-down discharge) within all the discharge cells. Due to the erase discharge, the wall charges produced by the setup discharge and unnecessary charges among space charges are erased.

During the address period, a scan signal of a negative polarity is sequentially applied to the scan electrodes Y and, at the same time, a data pulse of a positive polarity is selectively applied to the address electrodes X in synchronization with the scan signal. As a voltage difference between the scan signal and the data signal is added to a wall voltage produced during the reset period, an address discharge is generated within the discharge cells to which the data signal is applied. A signal maintained at a sustain voltage level is supplied to the sustain electrodes Z during the set-down period and the address period.

During the sustain period, a sustain signal is alternately applied to the scan electrodes Y and the sustain electrodes Z. Every time the sustain signal is applied, a sustain discharge of a surface discharge type is generated between the scan electrodes Y and the sustain electrodes Z.

Since the driving waveforms illustrated in FIG. 4 are only a first embodiment of the signals for driving the plasma display panel according to an exemplary embodiment, the present invention is not limited thereto. For instance, the pre-reset period may be omitted, polarities and voltage levels of the driving signals illustrated in FIG. 4 may be changed, and an erase signal for erasing the wall charges may be applied to the sustain electrodes after the generation of the sustain discharge. Further, the plasma display panel according to an exemplary embodiment may be driven in a signal sustain type for generating a sustain discharge by applying a sustain signal to either the scan electrode Y or the sustain electrode Z.

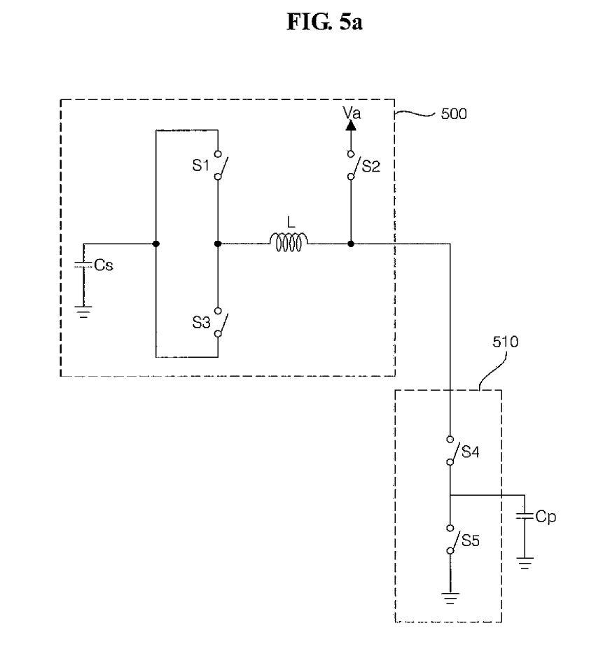

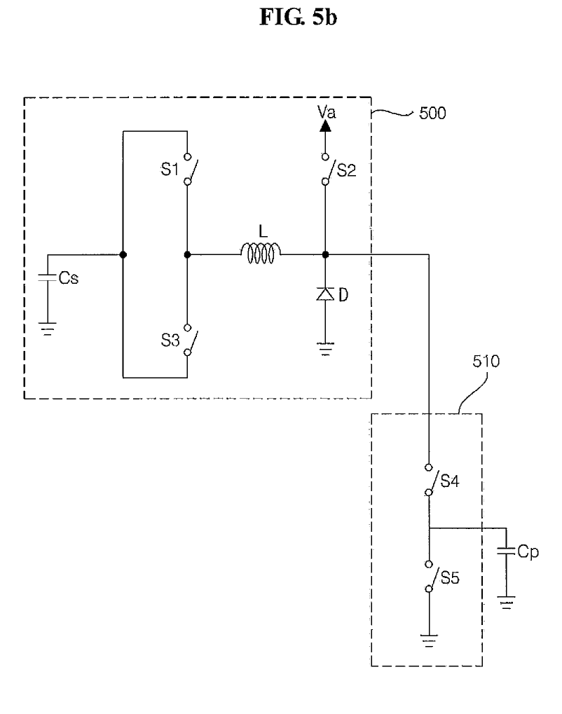

FIGS. 5a and 5b illustrate a first embodiment of a configuration of an address driving circuit of a plasma display panel according to an exemplary embodiment. The address driving circuit includes an energy recovery circuit 500 and an address driver 510.

As illustrated in FIG. 5a, the energy recovery circuit 500 includes an inductor L connected between the address driver 510 and an energy recovery capacitor Cs, first and third switches S1 and S3 connected in parallel between the energy recovery capacitor Cs and the inductor L, a second switch S2 connected between the inductor L and the address driver 510. The address driver 510 includes fourth and fifth switches S4 and S5 connected between the energy recovery circuit 500 and a panel capacitor Cp. The panel capacitor Cp equivalently indicates a capacitance formed between the address electrode lines X. The second switch S2 is connected to a voltage source (Va), and the fifth switch S5 is connected to a ground level voltage source (GND). The energy recovery capacitor Cs recovers a voltage charged to the panel capacitor Cp during the generation of an address discharge, is charged to the recovered voltage, and again supplies the charged voltage to the panel capacitor Cp. The voltage charged to the energy recovery capacitor Cs is changed depending on data input to the address driver 510. More specifically, the voltage charged to the energy recovery capacitor Cs is changed depending on a change in data input to a data integrated circuit (IC) of the address driver 510.

The data change means the change amount from a high level voltage to a low level voltage of a data signal or a change from a low level voltage to a high level voltage of a data signal.

Further, the data change may mean the number of switching operations for applying the data signal to the address electrode.

The inductor L and the panel capacitor Cp form a resonance circuit. When a data signal is supplied (i.e., input data is turned on), the fourth switch S4 of the address driver 510 is turned on. When a data signal is not supplied (i.e., input data is turned off), the fourth switch S4 is turned off. When input data is turned off, the fifth switch S5 of the address driver 510 is turned on. When input data is turned on, the fifth switch S5 is turned off.

A configuration of an address driving circuit of the plasma display panel according to an exemplary embodiment illustrated in FIG. 5b is substantially the same as that of the address driving circuit illustrated in FIG. 5a except an addition of a diode D to the address driving circuit of FIG. 5a. One terminal of the diode D is connected to a common terminal of the inductor L and the second switch S2 and the other terminal is grounded so that a voltage of the common terminal of the inductor L and the second switch S2 is not reduced to a voltage equal to or less than a ground level voltage during the driving of the plasma display panel. In this case, a cathode of the diode D is connected to the common terminal of the inductor L and the second switch S2, and an anode is grounded.

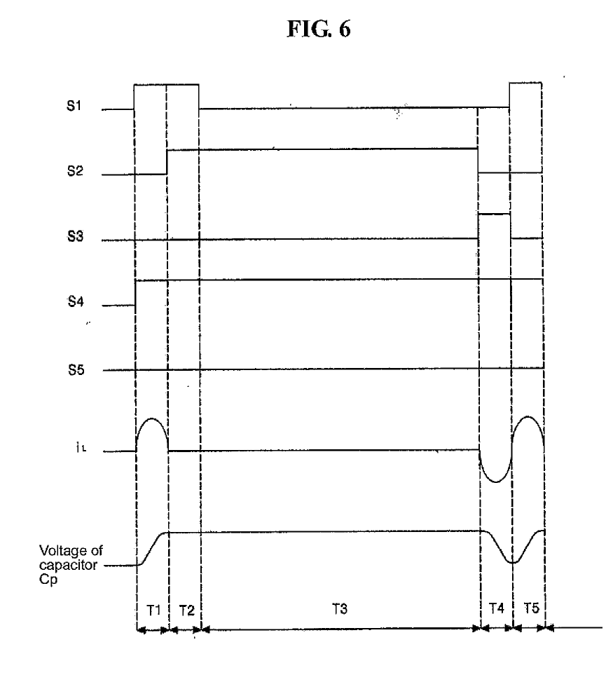

FIG. 6 illustrates On/off timing of switches of FIGS. 5a and 5b and a waveform of a data signal applied to a plasma display panel according to an exemplary embodiment. Operations of the address driving circuits of FIGS. 5a and 5b will be described in detail with reference to FIG. 6.

Assuming that, before a T1 interval, a voltage charged between the address electrode lines X (i.e., the voltage charged to the panel capacitor Cp) is 0V and a predetermined voltage is charged to the energy recovery capacitor Cs is charged. At the T1 interval, the first and fourth switches S1 and S4 are turned on. At this time, if no discharge cell is selected (that is, the data signal is not supplied to the address electrode line X), the fourth switch S4 is maintained in a turned off state, and a current path is formed from the energy recovery capacitor Cs through the first switch S1, the inductor L and the fourth switch S4 to the panel capacitor Cp, and the inductor L and the panel capacitor Cp form a resonance circuit. As a result, an address voltage Va is supplied to the panel capacitor Cp through the current path.

At a T2 interval, the second switch S2 is turned on. As a result, the address voltage Va is supplied to the address electrode line X so that a voltage of the panel capacitor Cp is more than the address voltage Va. This leads in the generation of a stable address discharge. At a T3 interval, the first switch S1 is turned off such that a voltage supplied to the address electrode line X is maintained at the address voltage Va.

At a T4 interval, the second switch S2 is turned off and the third switch S3 is turned on. As a result, a current path is formed from the panel capacitor Cp through the fourth switch S4, the inductor L and the third switch S3 to the energy recovery capacitor Cs, and thus the energy recovery capacitor Cs recovers a voltage charged to the panel capacitor Cp through the current path. When the panel capacitor Cp is discharged, a voltage of the panel capacitor Cp falls down, and at the same time, a predetermined voltage is charged to the energy recovery capacitor Cs. At a T5 interval, the switching operation of the T1 interval is repeated, thereby supplying the address signal to the address electrode line X. In fact, the data signal supplied to the address electrode lines X is obtained by periodically repeating the switching operations of the T1-T4 intervals.

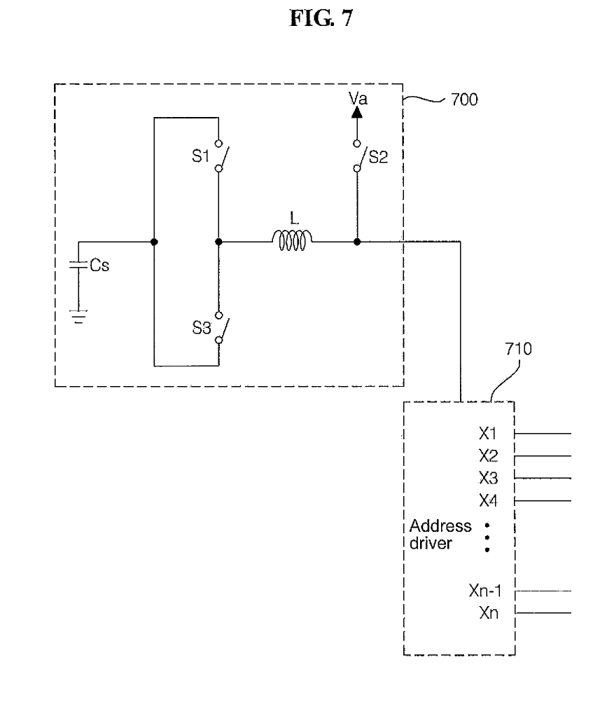

FIG. 7 is a circuit diagram of a second embodiment of a configuration of an address driving circuit of a plasma display panel according to an exemplary embodiment. As illustrated in FIG. 7, an address driver 710 are connected to each of a plurality of address electrode lines X1-Xn to apply a data signal output from an energy recovery circuit 700 to each of a plurality of address electrode lines X1 Xn. The address driver 710 may include a plurality of data ICs each applying a data signal to a predetermined number of address electrode lines. For instance, in case that the plasma display panel includes 3840 address electrode lines, a data signal can be applied to the plasma display panel using 40 data ICs each applying a data signal to 96 address electrode lines.

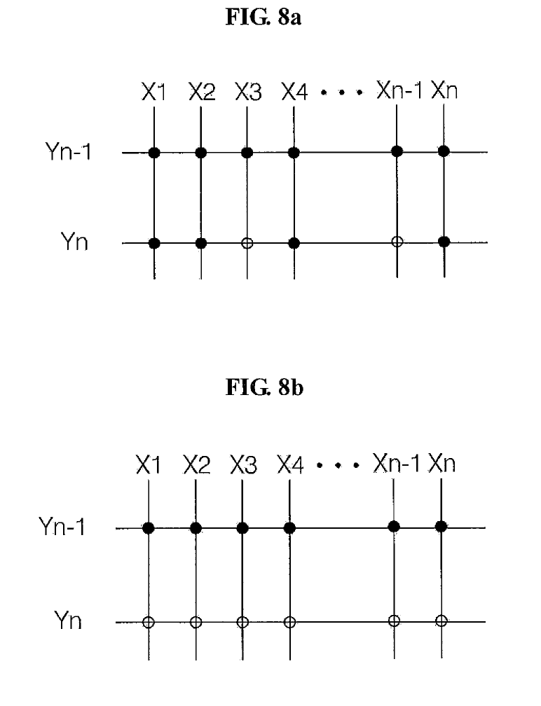

FIGS. 8a and 8b illustrate data supplied to an address electrode line. Operations of the address driving circuit of FIG. 7 will be described in detail with reference to FIGS. 8a and 8b.

FIGS. 8a and 8b illustrate data supplied to the (n−1)-th and n-th scan electrode lines Yn−1 and Yn. As illustrated in FIG. 8a, data supplied to all the discharge cells of the (n−1)-th scan electrode line Yn−1 is in an on-state. In the n-th scan electrode line Yn, data supplied to the third and (n−1)-th address electrode lines X3 and Xn−1 is in an off-state, and data supplied to the remaining discharge cells is in an on-state. At this time, the energy recovery capacitor Cs of FIG. 7 recovers the voltage charged to the third and (n−1)-th address electrode lines X3 and Xn−1 through an inner diode (not shown) of a switch (not shown) installed in the address driver 710.

As illustrated in FIG. 8b, data supplied to all the discharge cells of the n-th scan electrode line Yn is in an off-state. In this case, the energy recovery capacitor Cs recovers the voltage charged to the first through n-th address electrode lines X1-Xn.

Since the energy recovery capacitor Cs of FIG. 7 recovers the voltage charged to the third and (n−1)-th address electrode lines X3 and Xn−1 in FIG. 8a and the energy recovery capacitor Cs recovers the voltage charged to the first through n-th address electrode lines X1-Xn in FIG. 5b, the energy recovery capacitor Cs can recover the voltages of different magnitudes depending on data supplied to the address electrode lines X1-XN.

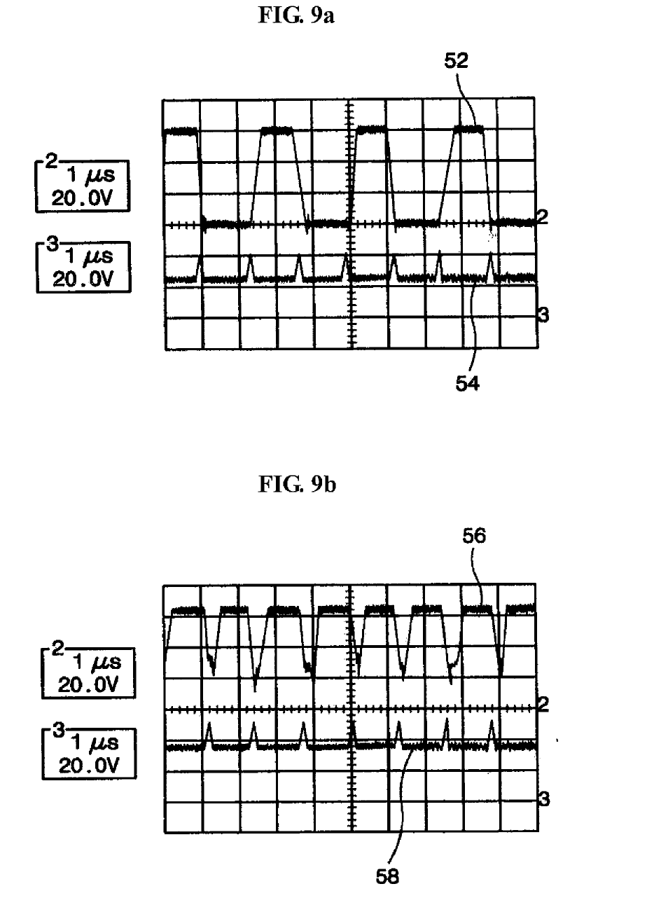

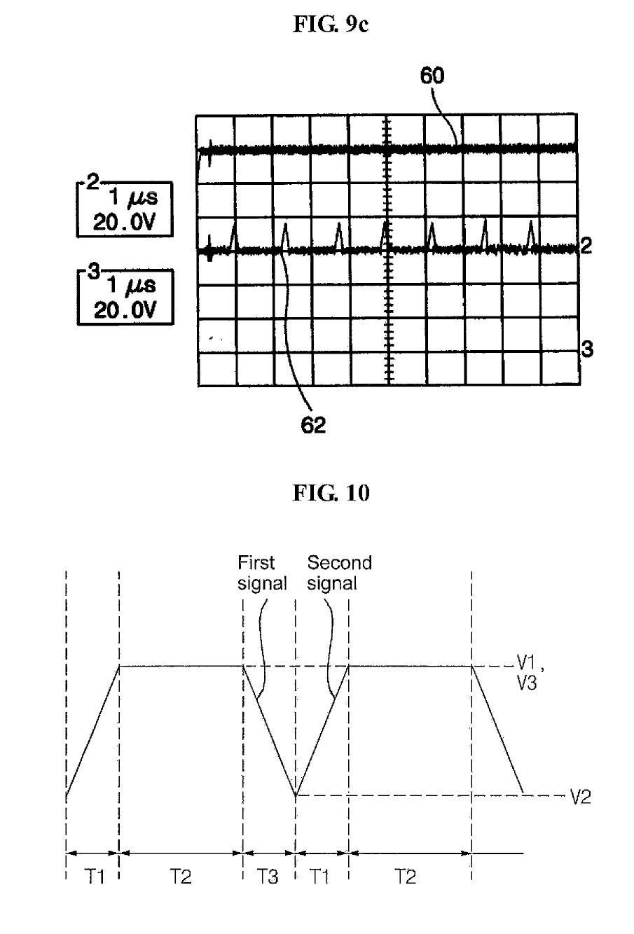

FIGS. 9a to 9c are graphs showing a relationship between a data change and a voltage charged to the energy recovery capacitor Cs, for instance, an address voltage is 60V.

FIG. 9a is a graph showing data 52 and a charging voltage 54 of the energy recovery capacitor Cs when the data 52 is changed in a ratio of 100% as the data 52 is supplied to the address electrode lines X1-Xn in an interlacing manner. In this case, as illustrated in FIG. 9a, a voltage of about 30V corresponding to half of the address voltage Va is charged to the energy recovery capacitor Cs. In other words, when the data supplied to the address electrode lines X1-Xn is changed in a ratio of 100%, the voltages charged to and discharged from the energy recovery capacitor Cs are balanced at 30V.

FIG. 9b is a graph showing data 56 and a charging voltage 58 of the energy recovery capacitor Cs when the data 56 supplied to the address electrode lines X1-Xn is changed in a ratio of 50%. In this case, as illustrated in FIG. 9b, a voltage of about 40V is charged to the energy recovery capacitor Cs. In other words, because the data change amount in FIG. 9b is less than the data change amount in FIG. 9a, the number of discharges of the charging voltage 58 of the energy recovery capacitor Cs is reduced. Accordingly, the charging voltage 58 of the energy recovery capacitor Cs in FIG. 9b is higher than the charging voltage 54 of the energy recovery capacitor Cs in FIG. 9a by 10V.

FIG. 9c is a graph showing data 60 and a charging voltage 62 of the energy recovery capacitor Cs when the data 60 is continuously in an on-state as the full white data 60 is supplied to the address electrode lines X1-Xn. In other words, when the full white data is supplied, that is, there is no change in the data, a voltage of about 60V close to the address voltage Va is charged to the energy recovery capacitor Cs. When there is no change in the data supplied to the address electrode lines X1-Xn, the energy recovery capacitor Cs recovers the charging voltage of the panel capacitor Cp, but the charging voltage of the energy recovery capacitor Cs is not discharged to the panel capacitor Cp. Accordingly, as illustrated in FIG. 9c, the voltage of the energy recovery capacitor Cs rises to the address voltage Va.

As above, it is determined whether the energy recovery circuit is or not operated depending on data supplied to the address electrode lines, and the charging voltage of the energy recovery capacitor Cs is changed. Therefore, when there is no change in the data, power consumption caused by switching operations of the energy recovery circuit can be prevented.

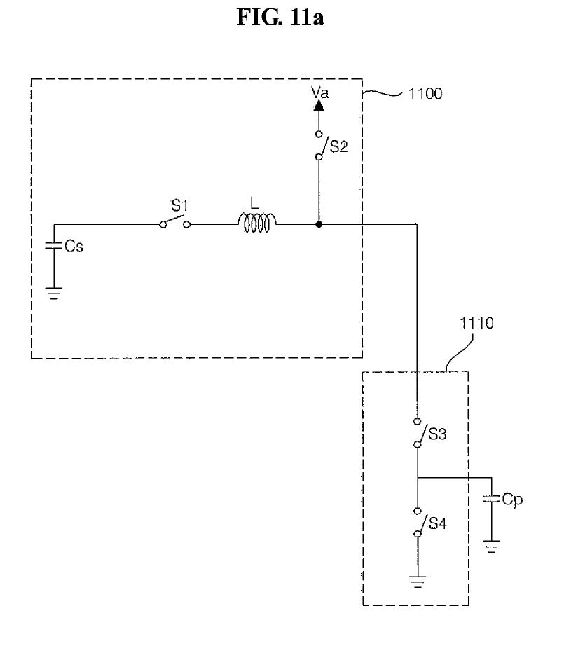

FIG. 10 schematically illustrates a form of a data signal produced by an address driving circuit according to an exemplary embodiment. As illustrated in FIG. 10, a data signal is divided into a T1 interval at which a voltage is charged to the panel capacitor Cp, a T2 interval at which the address voltage Va is supplied to the address electrode line X, and a T3 interval at which a charging voltage of the panel capacitor Cp is recovered and then the recovered voltage is charged to the energy recovery capacitor Cs. Immediately after the T3 interval, the T1 interval sequentially continues. In other words, the data signal includes a first signal gradually falling from a first voltage V1 to a second voltage v2 at the T3 interval, and a second signal which follows the first signal and gradually rises from the second voltage v2 to a third voltage V3 substantially equal to the first voltage V1.

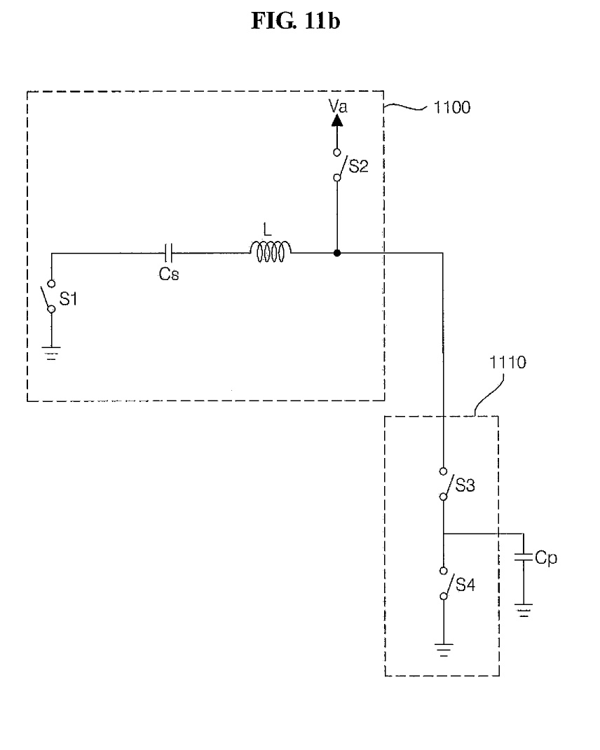

FIGS. 11a and 11b illustrate a third embodiment of a configuration of an address driving circuit of a plasma display panel according to an exemplary embodiment. The address driving circuits of FIGS. 11a and 11b each include an energy recovery circuit 1100 and an address driver 1110.

As illustrated in FIG. 11a, the energy recovery circuit 1100 includes an inductor L connected between the address driver 1110 and an energy recovery capacitor Cs, a first switch S1 connected between the energy recovery capacitor Cs and the inductor L, and a second switch S2 connected between the inductor L and the address driver 1110. The address driver 1110 includes third and fourth switches S3 and S4 connected between the energy recovery circuit 110 and a panel capacitor Cp. The panel capacitor Cp equivalently indicates a capacitance formed between the address electrode lines X. The second switch S2 is connected to a voltage source (Va), and the fourth switch S4 is connected to a ground level voltage source (GND).

In the energy recovery circuit 1100 of FIG. 11a, the first and second switches S1 and S2 of the energy recovery circuit 500 of FIGS. 5a and 5b are integrated into one switch (i.e., the first switch S1). Because resonance is continuously generated in the energy recovery circuit according to an exemplary embodiment, the energy recovery circuit does not need to include both a switch for supplying energy to the panel and a switch for recovering energy from the panel. As illustrated in FIG. 11a, energy is supplied to the panel and energy is recovered from the panel through a turn-on operation of the energy recovery/supply switch S1.

As illustrated in FIG. 11b, one terminal of the first switch S1 may be connected to the energy recovery capacitor Cs, and the other terminal may be grounded. The first switch S1 of FIG. 11b is turned on when energy is recovered from the panel.

As above, a data signal is applied to each of the address electrode lines X1-Xn through a plurality of data ICs each of which is connected to a predetermined number of address electrode lines. In case that the plurality of data ICs are connected to one energy recovery circuit, the driving efficiency of a small number of data ICs may be reduced depending on a change in data supplied to a large number of data ICs. For instance, in case that there is much change in the data supplied to one of the plurality of data ICs and there is almost no change in data supplied to the other data ICs, a voltage charged to the energy recovery capacitor Cs will rise up to almost the address voltage Va depending on a change in data supplied to a large number of data ICs (i.e., the other data ICs). In this case, although the data IC with much change in the supplied data needs an energy recovery operation, it is difficult to perform the energy recovery operation due to a rise in the charging voltage of the energy recovery capacitor Cs. Accordingly, the driving efficiency of the data IC with much change in the supplied data is reduced.

Accordingly, the driving efficiency of the data IC is improved by connecting the plurality of data ICs for applying the data signal to each of the address electrode lines X1-Xn to two or more energy recovery circuits.

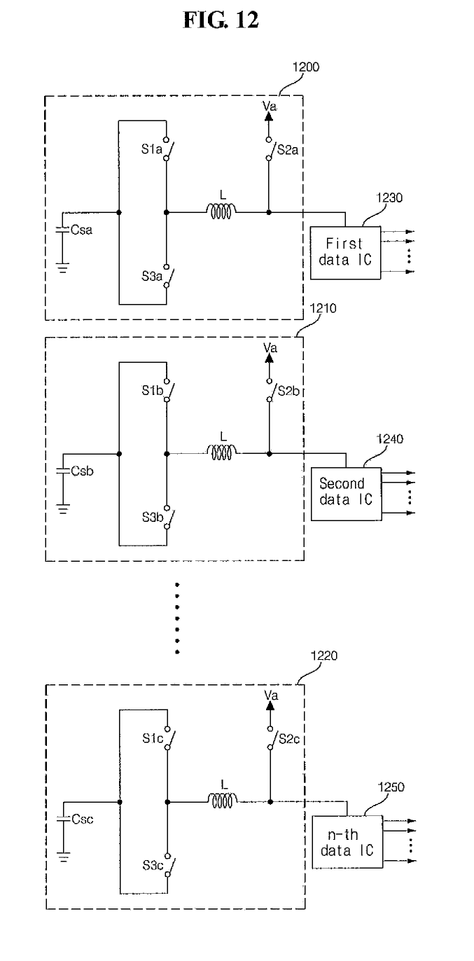

FIG. 12 is a circuit diagram of a fourth embodiment of a configuration of an address driving circuit of a plasma display panel according to an exemplary embodiment. In FIG. 12, a plurality of data ICs 1230, 1240 and 1250 are connected to a plurality of energy recovery circuits 1200, 1210 and 1220, respectively, and each of the plurality of data ICs 1230, 1240 and 1250 applies a data signal to a predetermined number of address electrode lines.

Voltages charged to energy recovery capacitors Csa, Csb, Csc of the energy recovery circuits 1200, 1210 and 1220 are different from depending on changes in data supplied to the data ICs 1230, 1240 and 1250 connected to the energy recovery circuits 1200, 1210 and 1220. In the other words, as the change in data supplied to the data ICs 1230, 1240 and 1250 increases, the voltages charged to the energy recovery capacitors Csa, Csb, Csc decreases. For instance, when the data change in the first data IC 1230 is less than the data change in the second data IC 1240, a voltage charged to the energy recovery capacitor Csa connected to the first data IC 1230 is higher than a voltage charged to the energy recovery capacitor Csb connected to the second data IC 1240.

Since a relationship between operations of the energy recovery circuits 1200, 1210 and 1220, operations of the data ICs 1230, 1240 and 1250, the data change in each of the data ICs 1230, 1240 and 1250, and the voltages charged to the energy recovery capacitors Csa, Csb, Csc was described with reference to FIGS. 5 to 10, a description thereof will be omitted.

As illustrated in FIG. 12, since the energy recovery circuits 1200, 1210 and 1220 are connected to the data ICs 1230, 1240 and 1250, respectively, and the voltages charged to the energy recovery capacitors Csa, Csb, Csc are different depending on the data change in each of the data ICs 1230, 1240 and 1250, the driving efficiency of the data ICs 1230, 1240 and 1250 is further improved.

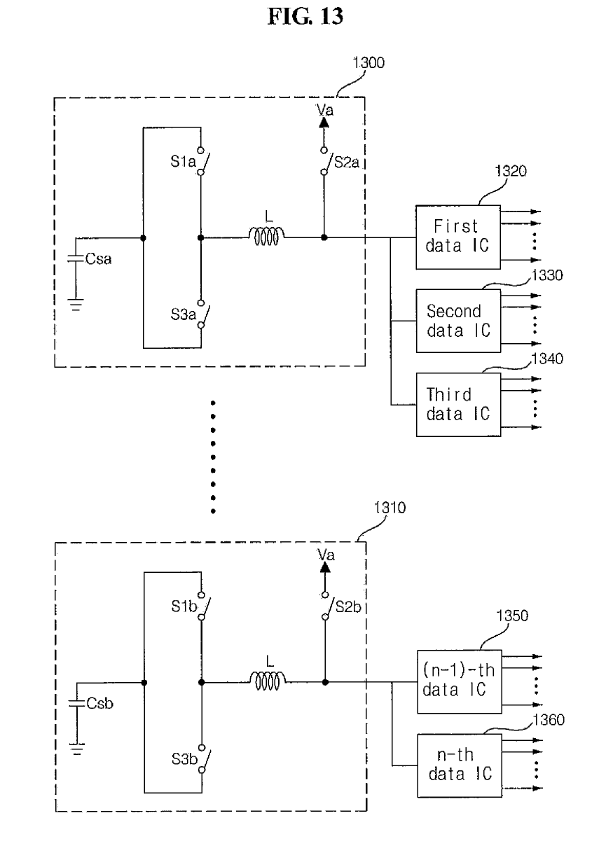

FIG. 13 is a circuit diagram of a fifth embodiment of a configuration of an address driving circuit of a plasma display panel according to an exemplary embodiment. In FIG. 13, a plurality of data ICs for applying a data signal to the address electrode lines X1-Xn are divided into two or more data IC groups, and the data ICs belonging to each data IC group are connected to one energy recovery circuit.

As illustrated in FIG. 137 an energy recovery circuit 1300 is connected to first, second and third data ICs 1320, 1330 and 1340, and an energy recovery circuit 1310 is connected to (n−1)-th and n-th data ICs 1350 and 1360. Therefore, voltages charged to an energy recovery capacitor Csa of the energy recovery circuit 1300 are different from depending on changes in data supplied to the first, second and third data ICs 1320, 1330 and 1340. Further, voltages charged to an energy recovery capacitor Csb of the energy recovery circuit 1310 are different from depending on changes in data supplied to the (n−1)-th and n-th data ICs 1350 and 1360. The voltage charged to the energy recovery capacitor Csa is different from the voltage charged to the energy recovery capacitor Csb depending on the data change.

Since a relationship between operations of the energy recovery circuits 1300 and 1310, operations of the data ICs 1320, 1330, 1340, 1350 and 1360, the data change in each of the data ICs 1320, 1330, 1340, 1350 and 1360, and the voltages charged to the energy recovery capacitors Csa and Csb was described with reference to FIGS. 5 to 10, a description thereof will be omitted.

The number of energy recovery circuits and the number of data ICs belonging to each of the data IC groups may vary.

The invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A driving apparatus for applying a data signal to each of a plurality of address electrodes of a plasma display panel, the driving apparatus comprising:
a plurality of data integrated circuits (ICs) that apply the data signal to the address electrodes depending on input data; and
a plurality of energy recovery circuits that recover a voltage applied to the address electrodes, and are charged to the recovered voltage, wherein voltages charged to the plurality of energy recovery circuits are different depending on changes in data input to the data ICs connected to the energy recovery circuits.

2. The driving apparatus of claim 1, wherein the plurality of data ICs are divided into data IC groups including one or more data ICs, and the plurality of energy recovery circuits are connected to the data IC groups, respectively.

3. The driving apparatus of claim 1, wherein the data change indicates the change amount from a high level to a low level of the data signal or the change amount from a low level to a high level of the data signal.

4. The driving apparatus of claim 1, wherein as the change in the data input to the data IC decreases, a voltage charged to the energy recovery circuit connected to the data IC increases.

5. The driving apparatus of claim 1, wherein when there is a change in the data input to the data IC, a voltage charged to the energy recovery circuit connected to the data IC is supplied to the address electrode.

6. The driving apparatus of claim 1, wherein the energy recovery circuit supplies a first signal gradually falling from a first voltage to a second voltage and a second signal which follows the first signal and gradually rises from the second voltage to a third voltage substantially equal to the first voltage to the data IC.

7. The driving apparatus of claim 1, wherein when there is no change in the data input to the data IC, a voltage charged to the energy recovery circuit is not supplied to the address electrode.

8. The driving apparatus of claim 1, wherein the energy recovery circuit includes:
an energy recovery capacitor that is charged to a voltage recovered from the address electrode;
an inductor that is connected to the data IC, the inductor and the plasma display panel forming a resonance circuit;
first and third switches that are connected between the energy recovery capacitor and the inductor in parallel; and
a second switch that is connected between an address voltage source and the data IC.

9. The driving apparatus of claim 8, wherein a common terminal of the inductor and the second switch is connected to one terminal of the data IC.

10. The driving apparatus of claim 8, wherein a common terminal of the inductor and the second switch is connected to one terminal of a diode, and the other terminal is grounded.

11. A driving apparatus for applying a data signal to each of a plurality of address electrodes of a plasma display panel, the driving apparatus comprising:
a plurality of data ICs that apply the data signal to the address electrodes depending on input data; and
a plurality of energy recovery circuits that recovers a voltage applied to the address electrodes, and are charged to the recovered voltage, wherein voltages charged to the plurality of energy recovery circuits are different depending on changes in data input to the data ICs connected to the energy recovery circuits, the energy recovery circuit including:
a first switch that recovers a voltage applied to the address electrode;
an energy recovery capacitor that is charged to a voltage recovered from the address electrode;
an inductor that is connected to the data IC, the inductor and the plasma display panel forming a resonance circuit; and
a second switch that is connected between an address voltage source and the data IC.

12. The driving apparatus of claim 11, wherein the first switch is positioned on a path for recovering a voltage from the address electrode and a path for recovering a voltage from the energy recovery capacitor and supplying the recovered voltage to the plasma display panel.

13. The driving apparatus of claim 11, wherein one terminal of the first switch is connected to the energy recovery capacitor, and the other terminal is grounded.

14. The driving apparatus of claim 11, wherein the plurality of data ICs are divided into data IC groups including one or more data ICs, and the plurality of energy recovery circuits are connected to the data IC groups, respectively.

15. The driving apparatus of claim 11, wherein the data change indicates the change amount from a high level to a low level of the data signal or a change from a low level to a high level of the data signal.

16. The driving apparatus of claim 11, wherein as the change in the data input to the data IC decreases, a voltage charged to the energy recovery circuit connected to the data IC increases.

17. The driving apparatus of claim 11, wherein when there is a change in the data input to the data IC, a voltage charged to the energy recovery circuit connected to the data IC is supplied to the address electrode.

18. The driving apparatus of claim 11, wherein the energy recovery circuit supplies a first signal gradually falling from a first voltage to a second voltage and a second signal which follows the first signal and gradually rises from the second voltage to a third voltage substantially equal to the first voltage to the data IC.

19. The driving apparatus of claim 11, wherein when there is no change in the data input to the data IC, a voltage charged to the energy recovery circuit is not supplied to the address electrode.

20. The driving apparatus of claim 11, wherein a common terminal of the inductor and the second switch is connected to one terminal of a diode, and the other terminal is grounded.
